(19) United States
(12) Patent Application Publication
(10) Pub. No.: US 2007/0186179 A1
(43) Pub. Date: Aug. 9, 2007

(54) Method for interacting with graphic service information of an apparatus

(76) Inventor: Frank John Williams, Los Alamitos, CA (US)

Correspondence Address: Frank John Williams, 2711 Saint Albans Dr., Los Alamitos, CA, 90720, US

(21) Appl. No.: 11/703,486

(22) Filed: Feb. 5, 2007

Related U.S. Application Data
(60) Provisional application No. 60/764,931, filed on Feb. 3, 2006.
(60) Provisional application No. 60/780,473, filed on Mar. 8, 2006.

(51) Int. Cl. G06F 3/00

(52) U.S. Cl. 715/771; 715/716

(57) ABSTRACT

A method for providing a graphic display of a first service information, such as a movie demonstrating a service procedure of an apparatus, and identifying a physical element, such as a key or button, for identifying a second service information of the apparatus; wherein said second service information is pertinent to the said first service information. In addition the method optionally incorporates at least one of a: identification of parts, and a protocol for ordering at least one part of the apparatus.

### FIELD OF THE PRESENT DISCLOSURE

This disclosure relates to a method for providing service information. More specifically, a method for providing an interactive graphic display for obtaining information such as a movie demonstrating a service procedure, and other service information including other procedures, events, unfortunate events and/or parts of the apparatus and/or service procedure of an apparatus.

### DESCRIPTION OF RELATED ART

Because of the evolution of the modern machine, service information to keep them functional had also developed into complicated and sometimes sophisticated service procedures. As a consequence, the amount of information and/or parts required to ensure a successful service procedure depends on many factors such as: the procedure, technical experience, technical expertise, parts, events and possible unfortunate events encountered during the procedure. In addition, large amounts of money, time, resources, and effort are spent every day training, educating, supporting, warranting, and assisting technicians and end-users alike.

The digital revolution, has transform the way people acquire information. Important and graphic information such as movies, slide-shows and pictures can quickly and effectively provide enormous amounts of information. In addition, these massive means for information distribution are readily available even through cell phones. Consequentially, such rich graphic information can potentially be used to effortlessly teach, support, and explain large numbers of people, thousands of miles away, the most intricate and detail service information such as a movie demonstrating a service procedure of virtually any apparatus. However, the evolution of the modern machine also implies that large quantities of service information is required to perform a successful service procedure such as a repair or troubleshoot of an apparatus. Specifically, other additional service information is many times required by each depending on many factors such as: viewer experience, viewer expertise, type of service procedure, type of apparatus, and others to name a few. Most importantly, including such specific and/or additional information like parts information in the above graphic information means (movies, etc.) implies that all viewers must see the information although it may not be required by all. For example, a movie demonstrating a service procedure such as replacing the fuser rollers of a copier illustrates the basic steps involved. However, 5% of the viewers performing the service procedure as shown will experience a broken bushing per se. Including the “broken bushing” information in the movie implies that 100% of viewers must be exposed to such information, which indeed is irrelevant to 95% of the viewer population. Furthermore, taking into consideration that the service procedure being demonstrate is of a complex nature, implies that many other possibilities and/or viewer information be required, thus rendering the current information methodologies confusing and/or non-functional to many viewers.

Recently, a new series of approaches have being conceived intending to alleviate the inconveniences of service information distribution. Patents such as: U.S. Pat. No. 6,317,570 Uchida et al, U.S. Pat. No. 5,802,429 Yamashita, US patent application publication US 2004/0186598 A1 Tanaka, and U.S. Pat. No. 5,715,496 Sawada et al, disclose several methods of obtaining information directly from the other apparatuses for intents of remote diagnosis, and possible equipment management. Unfortunately they all fail of providing service information (repair) to the client (viewer). In addition, U.S. Pat. No. 7,149,936 Deshpande, U.S. Pat. No. 3,932,948 Goddard, U.S. Pat. No. 4,102,569 Miyagi, and U.S. Pat. No. 3,999,307 Tsuda, referring to apparatus for instructional methods, fail to address complex and elaborate service procedures and information. Furthermore, all prior art fails to mention additional service information regarding parts of the apparatus, and parts commercialization.

In view of the foregoing and shortcomings, the disclosed inventive graphic display and methods teaches away from the recently used methodologies, while solving felt needs and provides unappreciated advantages distinguishing it over the prior art by also providing heretofore additional unknown advantages as described in the following summary.

### SUMMARY

It is therefore the object of the present invention to disclose a method for providing an interactive graphic information for providing service information of complex and elaborate service procedures of an apparatus, allowing at the same time to partition and/or organize additional and occasional service information relevant to each and/or every viewer. In such fashion, viewers can quickly, objectively, and affordably access important service information of elaborate service procedures without limiting or overwhelming the content of the graphic means for information. Furthermore, the method comprises the ability of adapting and managing current and/or new service information. This disclosure teaches certain benefits in construction and use which give rise to the objectives described below.

A primary objective inherent in the above described method is to provide advantages not taught by the prior art;

Another objective is to provide for the demonstration of elaborate and complex procedures;

Another objective is to provide a service procedure demonstrating an unfortunate event;

Another objective is to allow movies and other graphic means for information to quickly disseminate complex service information;

Another objective is to quickly permit the removal and/or addition of service information;

Another objective is to provide an intuitive method for viewers to obtain service information;

Another objective is to avoid the extrapolation of parts information;

Another objective is to diminished stress and tension experienced by the technician or end-user when performing service procedures by permitting the use of graphic means for information;

Another objective is to avoid the speculation of service procedures upon an unfortunate event;

Another objective is to fulfill end-users' needs to service their own equipment;

Another objective is to standardize the quantity and quantity of technical information;

Another objective is to alleviate warranty related repairs and/or expenses;

Another objective is to provide manufacturers' with a more compelling and complete medium to distribute service procedure information;

A further objective is to allow manufacturers and/or technical entities to quickly introduce or add new service procedure information handling unfortunate service events;

A further objective is to eliminate the possibility of identifying and/or ordering incorrect parts not relating to the relevant service procedure;

A further objective is to increase the troubleshooting success rate of technicians and end-users alike;

Other features and advantages of the described methods of use will become apparent from the following more detailed description, taken in conjunction with the accompanying drawings, which illustrate, by way of example, the principles of the presently described apparatus and method of its use.

### BRIEF DESCRIPTION OF THE DRAWINGS

The accompanying drawings illustrate at least one of the best mode embodiments of the present invention and method of use. In such drawings:

FIG. 1 illustrates a general non-limiting view of the exemplary elements of the inventive method, and method of operation;

FIG. 2 illustrates an exemplary cluster of means for providing service information;

FIG. 3 illustrates a non-limiting view of an exemplary character entry means being manipulated for viewer's intuitive interaction with service information;

FIG. 4 illustrates a non-limiting sample of character entry keys being modified;

FIG. 5 illustrates a non-limiting sample of a combination of interactive display information and interactive keyboard information;

FIG. 6 illustrates a non-limiting timeline chart of a movie demonstrating service information and keys providing service information associated to said movie's content.

### DETAILED DESCRIPTION OF THE PREFERRED EMBODIMENT

The above described drawing figures illustrate the described method for providing Graphic Interactive Service Information of an apparatus in at least one of its preferred, best mode embodiment, which is further defined in detail in the following description. Those having ordinary skill in the art may be able to make alterations and modifications what is described herein without departing from its spirit and scope. Therefore, it must be understood that what is illustrated is set forth only for the purposes of example and that it should not be taken as a limitation in the scope of the present apparatus and method of use.

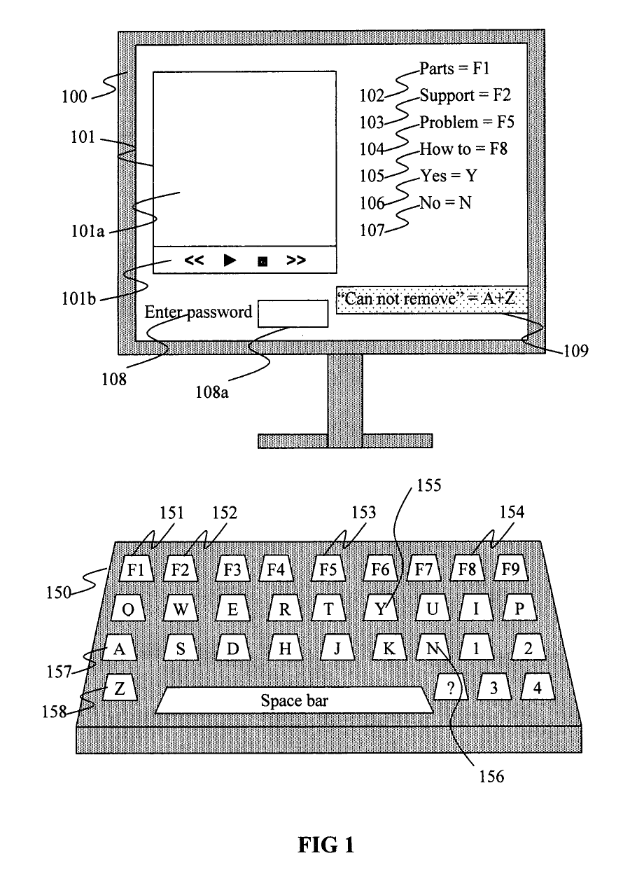

FIG. 1 illustrates a general non-limiting view of the exemplary elements of the inventive method, and method of operation. In FIG. 1, the display means 100 (FIG. 1) provides a movie player 101 (FIG. 1) with its respective graphic display 101a (FIG. 1) for displaying information, and its controls 101b (FIG. 1) for controlling the displayed information. For example, a movie demonstrating a service procedure is displayed on the player's display 101a (FIG. 1), which the viewer can rewind, forward, etc. utilizing the player's controls 101b (FIG. 1). Information identifying service information, such as: “Parts=F1” 102 (FIG. 1), “Support=F2” 103 (FIG. 1), “Problem=F5” 104 (FIG. 1), “How to=F8” 105 (FIG. 1), “Yes=Y” 106 (FIG. 1), and “No=N” 107 (FIG. 1) are displayed by the display means 100 (FIG. 1) of the apparatus to inform the viewer as to where, how and/or when such additional service information is available. In such fashion, the identifying information named “Parts=F1” 102 (FIG. 1) indicating that the “F1” key 151 (FIG. 1) on the viewer's keyboard 150 (FIG. 1) is utilized for providing parts information. For example, a viewer watching a movie demonstrating a service procedure displayed on the player display 101a (FIG. 1) decides or identifies a necessity for obtaining parts information. Simply by clicking the “F1” key 151 (FIG. 1) in his/her keyboard 150 (FIG. 1) reveals parts information, such as part number, availability, prices, etc. The identifying service information named “Support=F2” 103 (FIG. 1) implies that the “F2” key 152 (FIG. 1) on the viewer's keyboard 150 (FIG. 1) is used to provide support information. For example, a viewer finds a necessity for obtaining support information. Simply by clicking the “F2” key 152 (FIG. 1) on the his/her keyboard 150 (FIG. 1) displays a protocol for reaching and/or communicating with technical support, such as an e-chat. The identifying information named “Problem=F5” 104 (FIG. 1) implies that the “F5” key 153 (FIG. 1) on the viewer's keyboard 150 (FIG. 1) is used for providing service information relating to a problem encountered, such as a movie demonstrating a service procedure of a likely problem. For example, a viewer is watching a movie demonstrating the replacement of the drum unit in a copier, but yet can not remove the “drum's safety bracket” as shown. Simply by clicking the “F5” key 153 (FIG. 1) on the keyboard 150 (FIG. 1), another player appears demonstrating a slide show of what to do in the unfortunate event of not being able to remove the safety bracket as mentioned. The identifying information “How to=F8” 105 (FIG. 1) informs that the “F8” key 154 (FIG. 1) on the viewer's keyboard 150 (FIG. 1) is used to provide service information relation “how to” do particular action(s) mentioned in a movie or the alike, yet not been demonstrated. For example, the viewer is watching a movie describing a preventive maintenance of his/her printer, when the movie mentions to remove the printer cartridge. However, no where in the movie, the removal of the cartridge is shown. Therefore, the viewer can click the “F8’ key 154 (FIG. 1) in the keyboard 150 (FIG. 1) to see a small clip demonstrating “how to remove the cartridge in the printer.” The two service identifying information “Yes=Y” 106 (FIG. 1), and “No=N” 107 (FIG. 1) are used to describe or identify the keys on the keyboard 150 (FIG. 1) that the viewer must use in order to respond positively or negatively to the content in a movie per se. For example, the viewer watching a movie demonstrating the method to calibrate the colors in his/her printer is asked by the content in the movie if the printer can output a test page first. At this moment, the movie keeps repeating or stops and waits for the viewer to input a “yes” or a “no” answer. By pushing the “Y” key 155 (FIG. 1) on the keyboard 150 (FIG. 1), the viewer answer “yes” to the movie, thus continuing with other service information associated to a “yes” status. The “Enter password” information 108 (FIG. 1) and respective entry field 108a (FIG. 1), allows the viewer to recognize the necessity of entering or providing a password in order to proceed with the service information. Finally, the identifying information named “Can not remove=A+Z” 109 (FIG. 1) is of a dynamic nature; in other words, unlike some or most of the identifying information just mentioned, which stay on the display, the dynamic identifying information, appears and/or disappears as needed. For example, a movie demonstrating a service procedure, mentions the removal of a particular part. While this service action is being demonstrated, the “Can not remove=A+Z” information 109 (FIG. 1) appears, indicating to the viewer, that in case of the unfortunate event of not being able to remove the particular part as demonstrated, the viewer can respectively click both the A key 157 (FIG. 1) and the Z key 158 (FIG. 1) on the keyboard 150 (FIG. 1) to see another movie demonstrating a different procedure for removing the part.

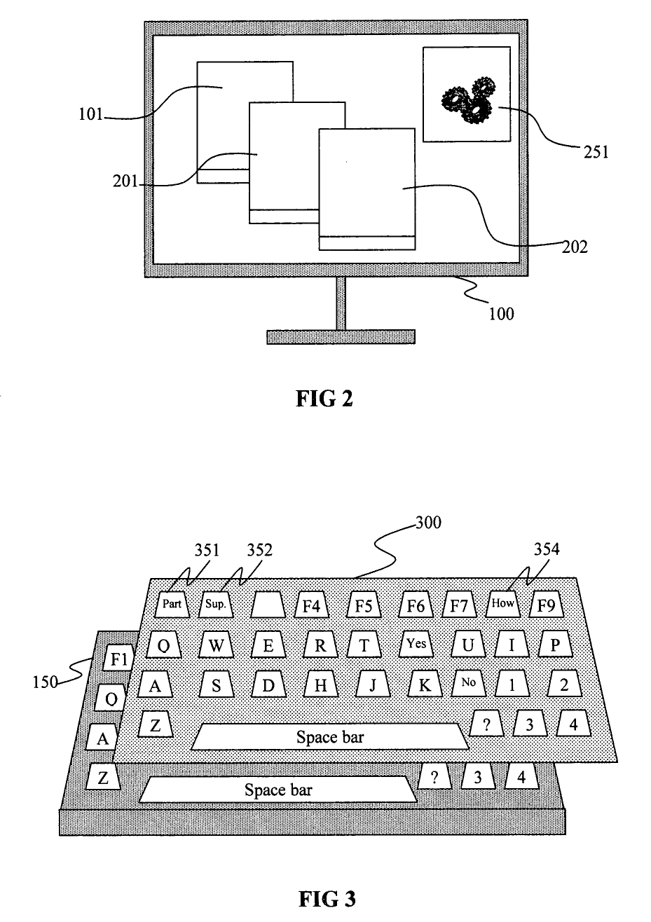

FIG. 2 illustrates an exemplary computer display 100 (FIG. 2) and several players such as the primary player 101 (FIG. 2), the secondary player 201 (FIG. 2) and the most currently used player 202 (FIG. 2). From the overlaying images of the players, it can be appreciated, that the second player 201 (FIG. 2) is a result of a key entry by the viewer when the first or primary player 101 (FIG. 2) was been used. The top or fully displayed player 202 (FIG. 2) is the most currently used player. In addition, FIG. 2 illustrates a parts protocol 251 (FIG. 2) for ordering a part from at least one of the service procedures being demonstrated by at least one of the mentioned players.

FIG. 3 illustrates a keyboard 150 (FIG. 3) been adapted to provide identifying information of service information. For example, the mantel or cover 300 (FIG. 3) is place on top of the keyboard 150 (FIG. 3) for modifying and/or renaming the keys to be used for providing service information. Therefore, in FIG. 3, the “Element” 351 (FIG. 3) named “Parts” will cover the “F1” key 151 (FIG. 3) of the keyboard 150 (FIG. 3), for identifying its respective service information, purpose and/or function.

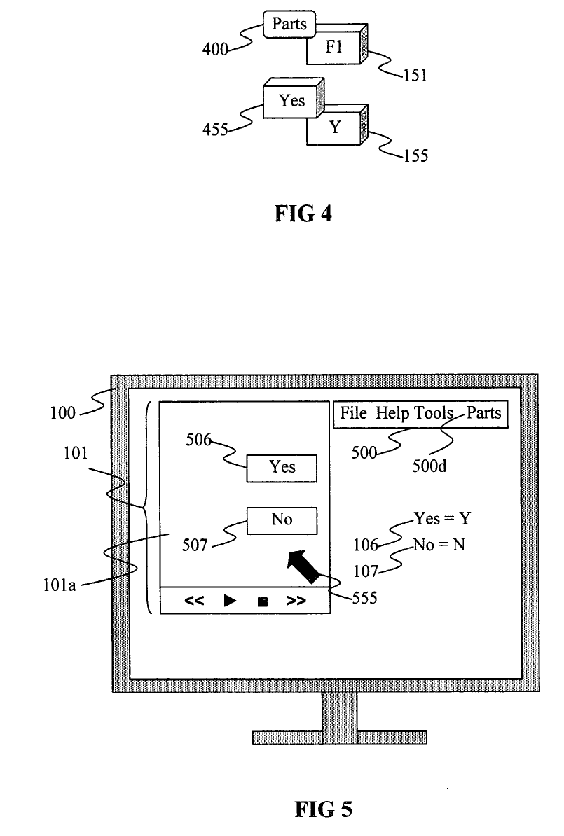

FIG. 4 illustrates a non-limiting example for identifying a key for providing service information. The label 400 (FIG. 4) is used to re-identify the “F1” 151 (FIG. 4) for providing service information. For example, a viewer (or other) attaches the label 400 (FIG. 4) named “Parts,” on the surface of the “F1” 151 (FIG. 4) modifying its identifying information for providing service information relating to parts. The replacement key 455 (FIG. 4) is used to replace the “Y” key 155 (FIG. 4), thus modifying its identifying information. For example, a person attaches the replacement “Yes” key 455 (FIG. 4) fitting it on the “Y” key 155 (FIG. 4) changing its appearance and identifying information for responding positively to service information.

FIG. 5 illustrates a non-limiting sample of a combination of an interactive movie, and an interactive keyboard method. The display means 100 (FIG. 5) is displaying a player 101 (FIG. 5). The player 101 (FIG. 5) is illustrating in its display 101a (FIG. 5) the interactive image “Yes” 506 (FIG. 5), and the interactive image “No” 507 (FIG. 5). In such fashion, a viewer to answer positively to a question from the movie of the player 101 (FIG. 5) can click the interactive image “Yes” 506 (FIG. 5) by using the cursor 555 (FIG. 5), and/or push the “Y” key in his/her keyboard as indicated by the identifying information “Yes=Y” 106 (FIG. 5). Also illustrated in FIG. 5 is an exemplary identifying menu 500 (FIG. 5) for identifying keys providing additional service information. For example, a viewer can click the “parts” menu 500d (FIG. 5) for identifying which key provides information of parts prices per se.

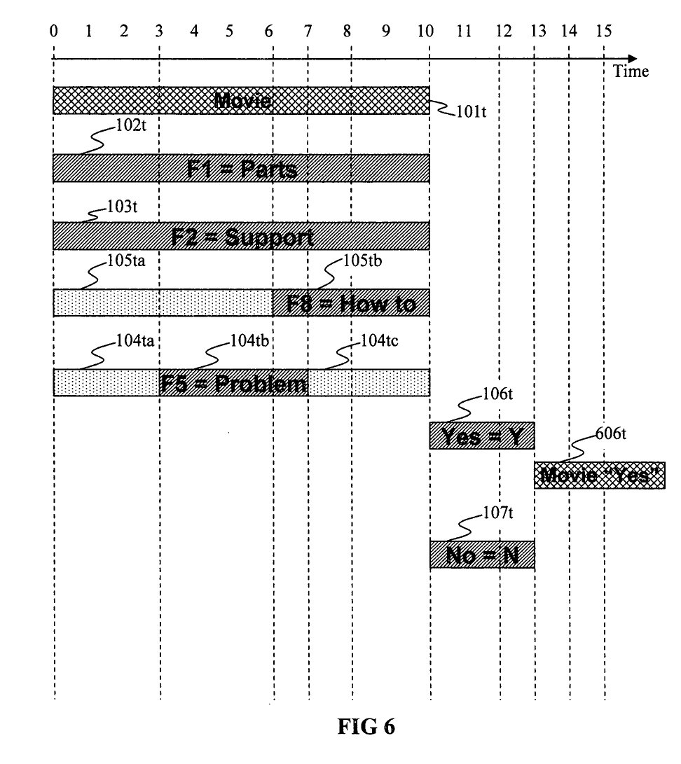

FIG. 6 a non-limiting timeline chart of a movie demonstrating service information and keys providing service information associated to said movie's content. In FIG. 6 the movie's timeline 101t (FIG. 6) indicates that the movie lasts or stops on the 10^{th} second. The timeline of the key “F1” 102t (FIG. 6) indicates that the “F1” is available for 10 seconds for providing parts information. For example a viewer watching a movie can push the “F1” key in his/her keyboard, any time during the movie to obtain service information regarding parts, such as part numbers and/or an order protocol to order at least one part. The timeline of the “F2” key 103t (FIG. 6) indicates that the “F2” key can provide the viewer support information for a total 10 seconds or the entire duration of the movie. For example, a viewer watching a movie can objectively push the “F2” in his/her keyboard any time during the movie to access a protocol to contact technical support, such as instant-messaging. The first timeline of the “F8” key 105ta (FIG. 6) indicates that for the first 6 seconds of the movie, the “F8” key is not accessible, it provides no information, and/or there is no service information associated to it. However, at the beginning of the 6^{th} second, the second timeline of the “F8” key 105tb (FIG. 6) indicated that the “F8” key can provide service information, such as another movie demonstrating a service procedure regarding “how to” information. For example, while a viewer is watching a movie demonstrating the service procedure of “removing the paper jammed on the printer's delivery door,” the movie mentions after the 6^{th} second to remove the toner cartridge, yet it never shows “how to” remove it. After the 6^{th} second, the viewer readily pushes the “F8” key in the keyboard to views another movie demonstrating “how to remove the toner cartridge” of the printer. The first portion of the timeline of the “F5” key 104ta (FIG. 6) indicates that the “F5” key is not associated for the first 3 seconds to any service information. The second portion of the timeline of the “F5” key 104tb (FIG. 6) indicates that the “F5” key is associated to a service information for a total 4 seconds addressing a possible problem encountered by the viewer. The last (3^{rd}) portion of the timeline of the “F5” key 104tc (FIG. 6) indicates that the “F5” is again, not associated to any service information. For example, a viewer is watching a movie demonstrating “removing the paper jammed on the printer's delivery door,” yet while the movie clearly demonstrates how to open the doors, the viewer can not open the doors as shown. Therefore, pushing the “F5” key on his/her keyboard, (only between the 3^{rd} and the 7^{th} seconds) provides the viewer another movie and/or player demonstrating a different method for opening the doors of the printer. FIG. 6 also shows that the movie is stop or paused on the 10^{th} second. This is because an answer, such as “yes” or “no” is expected form the viewer in order to continue demonstrating the procedure or continue to demonstrating at least one other service information. As a result, the timeline of the “Y” key 106t (FIG. 6) and the timeline of the “N’ key 107t (FIG. 6) indicate that both keys (Y and N) on the viewer keyboard are active and/or await for an input. Noteworthy, only one input (Y or N) will be accepted. In fact, FIG. 6 illustrates the timeline of a “Yes movie” 606t (FIG. 6) indicating that the viewer click the “Y” key for obtaining a corresponding a “Yes” type movie. For example, a viewer watching a movie is asked to answer “yes or no.” On this particular example the viewer has to answer “yes”, thus pushes the “Y” key and another movie addressing a positive type answer is displayed on a new player.

Noteworthy, without departing from the original spirit of the inventive method disclosed herein, many types of service information and means can be removed and/or added. For example, the computer's microphone can be used to allow speech entry from the viewer, such as saying the word “Yes” into the microphone for responding “affirmatively” to content on the ISIGD. In addition, other issues such as source of service information, forms of service information, controls of service information, associations of the service information, source for the associations of the service information, identifications, and others can all be differently manipulated and/or architected. For example, to achieve control of the delivery of service information, the buttons are controlled. In another controlling sample, the button's associations are controlled. In a further controlling example, the service information (content) is controlled. In another further example, the information for producing the association is encrypted within the service information. In a yet further example, the information for producing the association is provided in a different file, etc.

The enablements described in detail above are considered novel over the prior art of record and are considered critical to the operation of at least one aspect of the method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

### CONCLUSION

From the present disclosed inventive method, it can be appreciated a novel method of implementing a graphic display for providing service information of an apparatus, and implementing a keyboard for allowing interactivity for providing additional service information of the apparatus. The method permits to incorporate complex and elaborate service procedures into graphic display means, while also permitting the manipulation and adaptation of current and new service information. Furthermore, the method enhances the service experience of personnel while improving commerce possibilities for parts and/or upgrading equipment.

1. A method of providing interactive service information of an apparatus, the method comprising the steps of:
a) Implementing a display for providing a movie demonstrating a service procedure of an apparatus
b) Providing an information identifying a physical input element, such as a key or button
c) Implementing said information for identifying an additional service information of said apparatus
d) Identifying an entry for providing said additional service information of said apparatus
e) Providing said additional service information of said apparatus
